(19) United States
(12) Patent Application Publication
(10) Pub. No.: US 2004/0193841 A1
(43) Pub. Date: Sep. 30, 2004

(54) Matrix processing device in SMP node distributed memory type parallel computer

(75) Inventor: Makoto Nakanishi, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 10/798,287

(22) Filed: Mar. 12, 2004

(30) Foreign Application Priority Data
Mar. 31, 2003 (JP) 2003-095720

(51) Int. Cl. G06F 15/00

(52) U.S. Cl. 712/10

(57) ABSTRACT

In the LU decomposition of a matrix composed of blocks, the blocks to be updated of the matrix are vertically divided in each SMP node connected through a network and each of the divided blocks is allocated to each node. This process is also repeatedly applied to new blocks to be updated later, and the newly divided blocks are also cyclically allocated to each node. Each node updates allocated divided blocks in the original order of blocks. Since by sequentially updating blocks, the amount of processed blocks of each node equally increases, load can be equally distributed.

### BACKGROUND OF THE INVENTION

1. Field of the Invention

The present invention relates to a matrix processing device and method in an SMP (symmetric multi-processor) node distributed memory type parallel computer.

2. Description of the Related Art

In the solution of simultaneous linear equations developed for a parallel computer in which vector processors are connected by crossbars, each block to be LU-decomposed is cyclically allocated to each processor element to execute LU decomposition. In a vector processor, even if the width of a block is reduced, the efficiency of the costly computation of an update portion using a matrix product is very high. Therefore, regarding a matrix as the cyclic allocation of a block with a width of approximately 12, firstly, one CPU sequentially computes blocks by means of LU decomposition, and then the result is divided into a plurality of portions. Each portion is transferred to each processor and is updated using a matrix product.

FIG. 1 shows the basic algorithm for an LU decomposition of a superscalar parallel computer.

LU decomposition is applied to an array A using a method obtained by blocking exterior Gauss's elimination method. Array A is decomposed by a block width d.

In the k-th process, an update portion A^{(k)} is updated as follows:

A^{(k)}=A^{(k)}−L2^{(k)}×U2^{(k)} (1)

In the (k+1)-th process, A^{(k)} is decomposed by width d, and a matrix smaller by d is updated using the same equation.

L2^{(k)} and U2^{(k)} must be computed according to the following equation.

In the case of updating using equation (1) A^{(k)} is decomposed as follows,

\overline{A}^{(k)}=(L1^{(k)T})^{T}U1^{(k)}

and it is updated as follows.

U2^{(k)}=L1^{(k)-1}U2^{(k)}

The above-mentioned block LU decomposition is disclosed in Patent document 1.

Besides, as technologies for computing a matrix by a parallel computer, Patent document 2, 3, 4 and 5 disclose a method for storing the coefficient matrix of a simultaneous linear equation in an external storage device, a method for a vector computer, a method for simultaneously eliminating multi-pivot strings and a method for executing LU decomposition after rearranging the order of each element of a sparse matrix to make an edged-block diagonal matrix, respectively.

Patent document 1: Japanese Patent Laid-open No. 2002-163246

Patent document 2: Japanese Patent Laid-open No. 9-179851

Patent document 3: Japanese Patent Laid-open No. 11-66041

Patent document 4: Japanese Patent Laid-open No. 5-20349

Patent document 5: Japanese Patent Laid-open No. 3-229363

If the above-mentioned LU decomposition for a superscalar parallel computer is executed by a parallel computer system in which one node is simply designated to be an SMP, the following problems occur.

In order to efficiently compute a matrix product in an SMP node, the block width that is set to 12 in a vector computer must be increased to approximately 1,000.

5. In this case, if a matrix is processed assuming that an SMP node is cyclically allocated to each processor for each block, the amount of update computation using a matrix product often becomes unequal among processors, and paralleling efficiency remarkably degrades.

6. If the LU decomposition of a block with a width of approximately 1,000 in one node is computed only in the node, other nodes enters an idle state. In this case, since this idle time increases in proportion to the width, paralleling efficiency remarkably degrades.

(3) If the number of CPUs constituting an SMP node is increased, in the conventional method, the amount of transfer appears to relatively increase although it is approximately 0.5 n²×1.5 elements (in this case, elements are matrix elements), since a transfer rate relatively degrades as computation ability increases. Therefore, the efficiency fairly degrades. The degradation caused in (1) through (3) above incurs performance degradation of approximately 20 through 25% as a whole.

### SUMMARY OF THE INVENTION

It is an object of the present invention to provide a device and a method for enabling an SMP node distributed memory type parallel computer to process matrices at high speed.

The matrix processing method of the present invention is adopted in a parallel computer system in which a plurality of processors and a plurality of node including memory are connected through a network. The method comprises a first allocation step of distributing and allocating one combination of bundles of column blocks of a portion of a matrix, cyclically allocated, to each node in order to process the combination of bundles of column blocks, a separation step of separating a diagonal block and a column block beneath the diagonal block of the combination of bundles of column blocks from the other blocks, a second allocation step of redundantly allocating the diagonal block to each node and also allocating one block obtained by one-dimensionally dividing the column block in each of the plurality of nodes while communicating in parallel, an LU decomposition step of executing in parallel the LU decomposition of the diagonal block and the allocated block in each node while communicating with each node and an update step of updating the other blocks of the matrix using the LU-decomposed block.

According to the present invention, since computation load can be distributed among nodes and the degree of paralleling can be improved, higher-speed matrix processing can be realized. Since computation and data transfer are conducted in parallel, the processing ability of a computer can be improved regardless of its data transfer rate.

### BRIEF DESCRIPTION OF THE DRAWINGS

FIG. 1 shows the basic algorithm for the LU decomposition of a superscalar parallel computer;

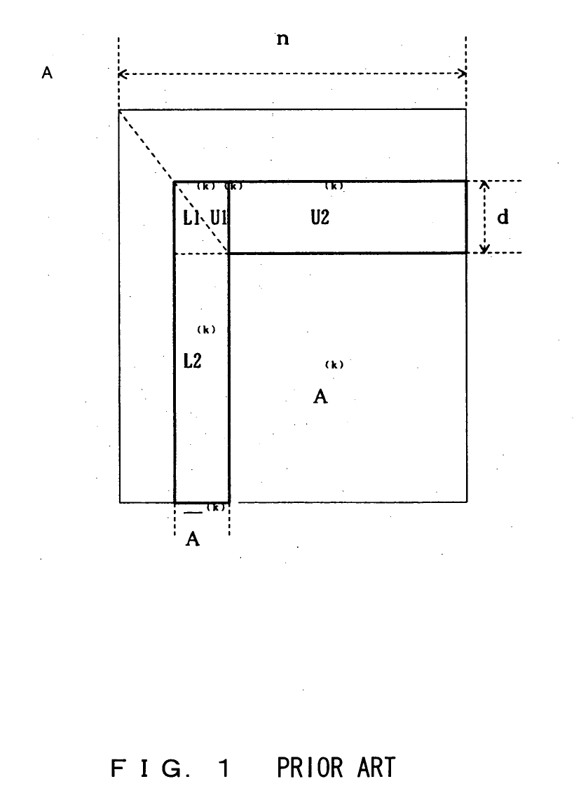

FIGS. 2A and 2B show the basic comprehensive configuration of an SMP node distributed memory type parallel computer adopting the preferred embodiment of the present invention;

FIG. 3 is a flowchart showing the entire process according to the preferred embodiment of the present invention;

FIG. 4 shows the general concept of the preferred embodiment of the present invention;

FIG. 5 shows a state where blocks with a relatively small width are cyclically allocated (No. 1);

FIG. 6 shows a state where blocks with a relatively small width are cyclically allocated (No. 2);

FIG. 7 shows the update process of the blocks allocated as shown in FIGS. 5 and 6;

FIGS. 8A and 8B show a recursive LU decomposition procedure;

FIG. 9 shows the update of the subblock other than a diagonal block;

FIG. 10 shows the update process of a row block (No. 1);

FIG. 11 shows the update process of a row block (No. 2);

FIG. 12 shows the update process of a row block (No. 3);

FIG. 13 is a flowchart of the preferred embodiment of the present invention (No. 1);

FIG. 14 is a flowchart of the preferred embodiment of the present invention (No. 2);

FIG. 15 is a flowchart of the preferred embodiment of the present invention (No. 3);

FIG. 16 is a flowchart of the preferred embodiment of the present invention (No. 4);

FIG. 17 is a flowchart of the preferred embodiment of the present invention (No. 5);

FIG. 18 is a flowchart of the preferred embodiment of the present invention (No. 6);

FIG. 19 is a flowchart of the preferred embodiment of the present invention (No. 7);

FIG. 20 is a flowchart of the preferred embodiment of the present invention (No. 8);

FIG. 21 is a flowchart of the preferred embodiment of the present invention (No. 9);

FIG. 22 is a flowchart of the preferred embodiment of the present invention (No. 10);

FIG. 23 is a flowchart of the preferred embodiment of the present invention (No. 11);

FIG. 24 is a flowchart of the preferred embodiment of the present invention (No. 12);

FIG. 25 is a flowchart of the preferred embodiment of the present invention (No. 13); and

FIG. 26 is a flowchart of the preferred embodiment of the present invention (No. 14).

### DESCRIPTION OF THE PREFERRED EMBODIMENTS

The preferred embodiments of the present invention proposes a method for processing a portion in which load is completely balanced even if a block width is increased and which is sequentially computed by one CPU, in parallel among nodes.

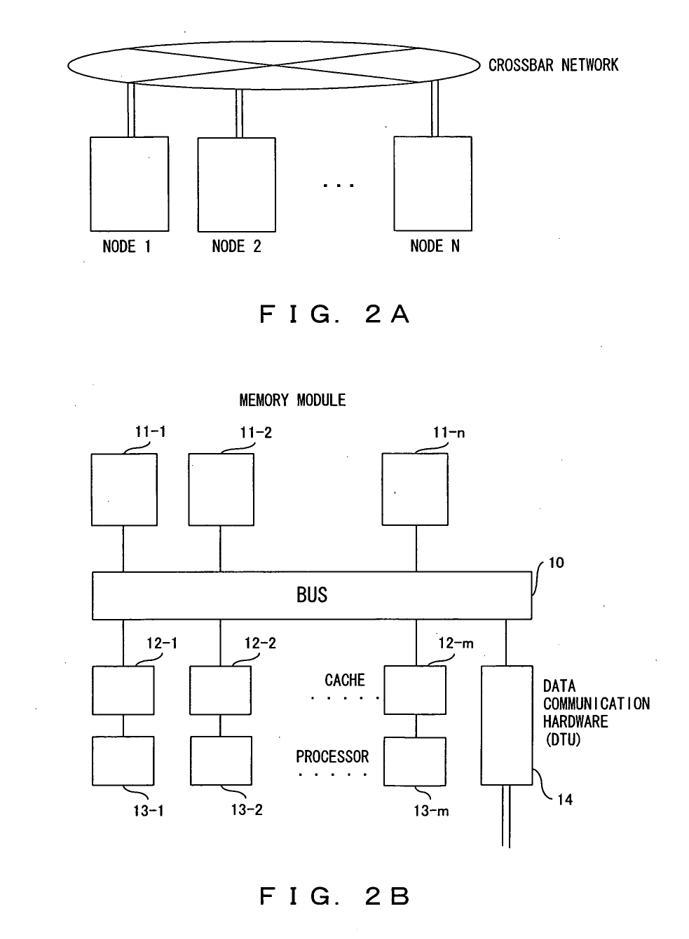

FIGS. 2A and 2B show the basic comprehensive configuration of an SMP node distributed memory type parallel computer adopting the preferred embodiment of the present invention.

As shown in FIG. 2A, nodes 1 through N are connected to a crossbar network and can communicate with each other. As shown in FIG. 2B, since in each node, memory modules 11-1 through 11-n, and pairs of processors 13-1 through 13-m and caches 12-1 through 12-m are connected to each other, they can communicate with each other. Data communication hardware (DTU) 14 is connected to the crossbar network shown in FIG. 2A, and can communicate with another node.

Firstly, column blocks each with a comparatively small width are cyclically allocated to a node. A combination of bundles of blocks in each node is regarded as one matrix. In this case, a matrix can be regarded to be in a state where a matrix is two-dimensionally and equally divided and the divided blocks are distributed and allocated to a plurality of nodes. This state is dynamically modified to a one-dimensionally and equally divided arrangement using parallel transfer. In this case, to one-dimensionally and two-dimensionally divide a matrix means to divide it vertically and horizontally, respectively, if the matrix is a rectangle or a square. In this case, a square portion at the top is shared by all nodes.

This modification of distributed allocation enables the use of parallel transfer using the crossbar network, and the amount of transfer decreases to one obtained by dividing it by the number of nodes. Then, this LU decomposition of blocks in the one-dimensionally and equally divided arrangement is executed in parallel in all nodes by inter-node communication. In this case, in order to improve paralleling efficiency and also to improve the performance of the SMP, reflective LU decomposition is executed by further decomposing the blocks.

When this LU decomposition of blocks is completed, each node has information about a diagonal block portion and information about a one-dimensionally and equally divided portion. Therefore, using both segments of information, a row block portion is updated, and other portions excluding the upper left corner where a column and a row intersecte are updated using the row block portion and a stored column block portion. Then, at the time of update, this information is transferred to its adjacent node, and subsequent update is prepared. This transfer can be conducted simultaneously with computation. By repeating these operations, all portions to be updated can be updated.

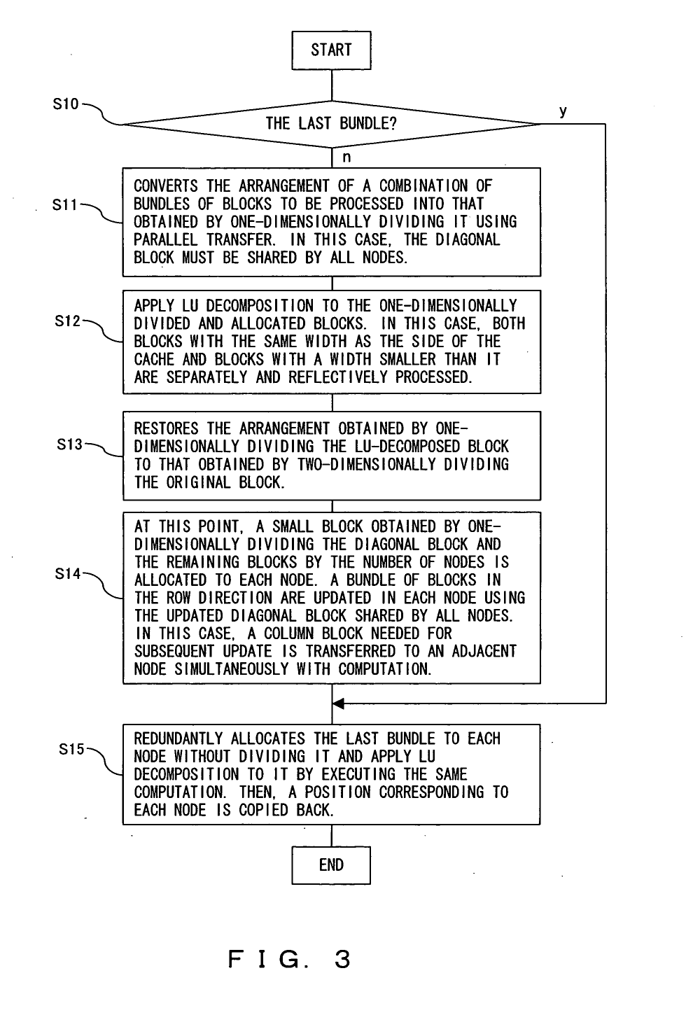

FIG. 3 is a flowchart showing the entire process according to the preferred embodiment of the present invention.

Firstly, in step S10, it is determined whether it is the last bundle. If the determination in step S10 is yes, the process proceeds to step S15. If the determination in step S10 is no, in step S11, the arrangement is converted into the arrangement of a combination of bundles of blocks to be processed using parallel transfer. In this case, the diagonal block must be shared by all nodes. In step S12, LU decomposition is applied to the one-dimensionally divided and allocated blocks. In this case, both blocks with the same width as the size of a cache and blocks with a width smaller than it are separately and reflectively processed. In step S13, the arrangement obtained by one-dimensionally dividing the LU-decomposed block is restored to that obtained by two-dimensionally dividing the original block, using parallel transfer. At this point, diagonal blocks and small blocks obtained by one-dimensionally dividing the remaining blocks by the number of nodes are allocated to each node. In step S14, a bundle of blocks in the row direction are updated in each node using the updated diagonal block shared by all nodes. In this case, column blocks needed for subsequent update is transferred to its adjacent node simultaneously with computation. In step S15, the last bundle of blocks are redundantly allocated to each node without being divided and LU decomposition is applied to it by executing the same computation. A portion corresponding to each node is copied back. Then, the process terminates.

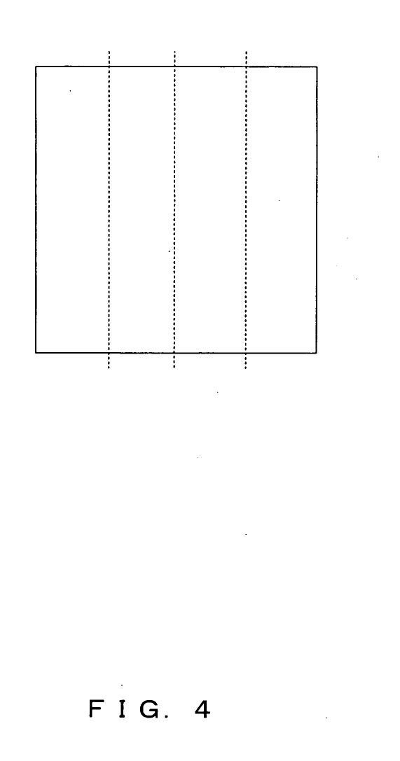

FIG. 4 shows the general concept of the preferred embodiment of the present invention.

As shown in FIG. 4, for example, a matrix is equally divided into four, and is distributed and arranged to each node. Column blocks are allocated to each node and are cyclically processed. In this case, a combination of bundles of blocks is regarded as one block. This block is one-dimensionally divided except a diagonal block portion, and is re-allocated to each node using communication.

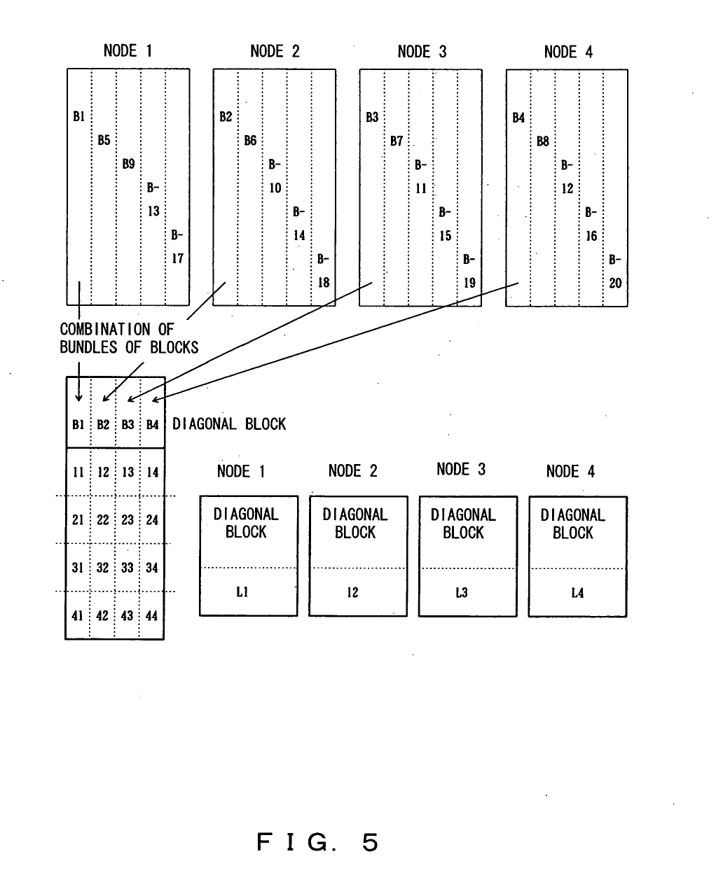

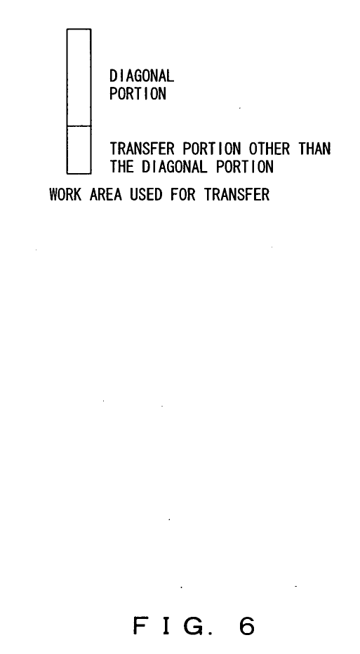

FIGS. 5 and 6 show a state where blocks with a comparatively small width are cyclically allocated.

As shown in FIGS. 5 and 6, a part of the column block of a matrix is further divided into smaller column blocks, and the divided columns are allocated to each node (in this case, the number of nodes four) . Such allocation modification means to convert a two-dimensionally divided block into a one-dimensionally divided block (diagonal blocks are shared and stored) . This conversion can be made using the parallel transfer of the crossbar network.

This can be realized by transferring in parallel each of sets of diagonally arrayed blocks, (11, 22, 33, 44), (12, 23, 34, 41), (13, 24, 31, 42) and (14, 21, 32, 43) to each node (transferring them from a two-dimensionally allocated processor to a one-dimensionally allocated processor) when virtually dividing a combination of bundles of blocks like a mesh. In this case, by transmitting a diagonal block portion in a large size sufficient to be shared by all nodes together, the amount of transfer is reduced to one obtained by dividing it by the number of processors.

Then, LU deposition is applied to the column blocks whose distribution/allocation is modified thus by equally allocating the divided diagonal and the remaining blocks to each node while conducting inter-node communication and establishing inter-node synchronization. LU deposition in each node is executed by conducting thread paralleling.

This LU decomposition by thread paralleling is executed by a recursive procedure having a double structure so as to efficiently execute it in the cache. Specifically, a primary recursive procedure is applied to blocks with a width up to a specific value. Blocks with a smaller width than the value are processed by combining a diagonal portion and a portion obtained by equally dividing the remaining portion by the number of threads for the purpose of thread paralleling and copying them to a continuous work area. Thus, data in the cache is effectively used.

Since the diagonal block portion shared by all nodes is redundantly computed among the nodes, the paralleling efficiency of inter-node LU decomposition degrades. The overhead incurred when computing blocks in parallel in each node using a thread can be reduced by executing LU decomposition by a double recursive procedure.

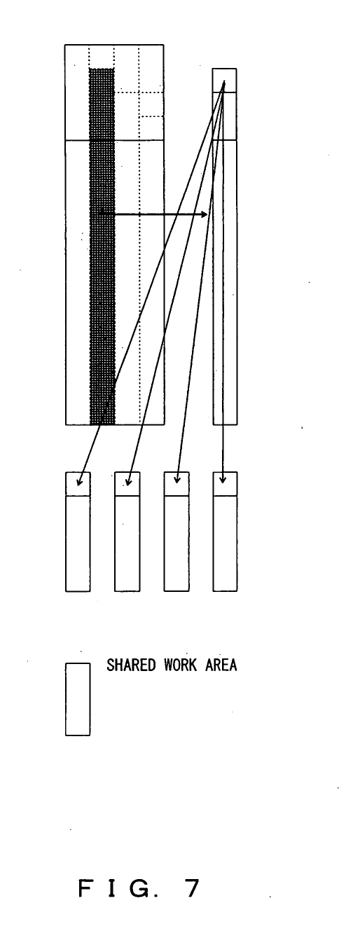

FIG. 7 shows the update process of the blocks allocated as shown in FIGS. 5 and 6.

The utmost left block shown in FIG. 7 is obtained by redundantly allocating diagonal blocks to each node and also allocating blocks obtained by one-dimensionally and equally dividing the remaining blocks to a work area. This is the state of a specific node. A primary recursive procedure is applied to blocks with the minimum width.

After the LU decomposition of the minimum block is completed, row blocks and an update portion are updated in parallel by equally dividing the area to be updated.

The LU decomposition of the minimum block portion is further executed as follows by copying the diagonal portion of a block with the minimum width to the local area (with approximately the size of a cache) of each thread and also copying the remaining portion by equally dividing it.

LU decomposition is further executed by a recursive procedure, using this area. A pivot is determined, and information for converting the relative position of the pivot into the relative position in a node, and a position in the entire matrix is stored in each thread in order to replace rows.

If the pivot is located inside the diagonal portion of the local area of a thread, they can be independently replaced in each thread.

If it is located outside the diagonal block, the process of blocks varies depending on the position.

5. If the pivot is located inside the diagonal block redundantly allocated when dividing and allocating blocks to nodes

In this case, there is no need for inter-node communication, and blocks can be independently processed in each node.

6. If the pivot is located outside the diagonal block when dividing and allocating blocks to nodes

In this case, it is determined to which node the maximum pivot belongs by communicating about the maximum value of the pivot among threads, that is, the maximum value in the node, with all nodes. After determining it, rows are replaced in a node having the maximum pivot. Then, the replaced rows (pivot row) are notified to the other nodes.

The following pivot process is performed.

LU decomposition doubly executed by secondary thread paralleling after LU decomposition by a recursive procedure having a double structure, can be executed in parallel to LU decomposition in the local area of each thread while performing the above-mentioned pivot replacement.

The history of pivot replacement is redundantly stored in the common memory of each node.

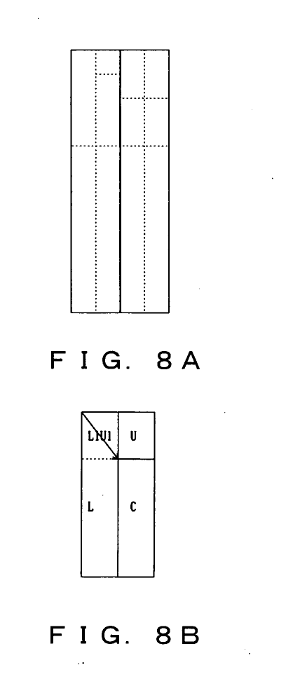

FIGS. 8A and 8B show the procedure of the recursive LU decomposition.

The procedure of the recursive LU decomposition is as follows.

The layout shown in FIG. 8B is referenced. When the LU decomposition of the diagonal block portion shown in FIG. 8B is completed, U updates as follows, using L1:

U→L1′U and C→L×U

The recursive procedure is a method for dividing an area to which LU decomposition is applied into a former half and a latter half and recursively applying LU decomposition to them, regarding the divided areas as the targets of LU decomposition. If a block width is smaller than a specific minimum value, the conventional LU decomposition is applied to blocks with such a width.

FIG. 8A shows a state where an area is divided into two by a thick line, and the left side is further divided into two in the course of LU decomposition. The left side divided by a thick line corresponds to the layout shown in FIG. 8B. When the LU decomposition of the portion C of this layout is completed, the LU decomposition of the left side divided by the thick row is also completed.

Portion C on the right side is updated by applying the layout shown in FIG. 8B to the entire block, based on this information about the left side. After the update is completed, LU decomposition is executed by similarly applying the layout shown in FIG. 8B to the right side. -The replacement of rows after the LU decomposition of a block, update of row block and -update by rank p update

After executing LU decomposition in parallel in a state where blocks are re-allocated to nodes, using inter-node communication and thread paralleling, the diagonal blocks commonly located in each node and one portion obtained by equally dividing the remaining portion are left with each having the resulted value of LU decomposition.

Firstly, rows are replaced using information about the replacement history of the pivot in each node and information about a diagonal block. Then, a row block portion is updated. Then, an update portion is updated using a column block portion obtained by dividing the remaining portion of a block and an updated row block portion. A divided column block portion used for update simultaneously with this computation is transferred to its adjacent node in each nodes.

This transfer is made to transmit information needed for subsequent update simultaneously with the computation to prepare for subsequent computation, and by executing this transfer simultaneously with computation, the computation can be efficiently continued.

In order to make the effective update of a partial matrix product even if the number of threads is large, a matrix is divided in such a way that the update area of a matrix product to be computed in each thread becomes close to a square. The update area that takes charge of update in each node is a square. The update of this area is shared by each node in order to prevent performance degradation from occurring.

For this purpose, the update area is divided in such a way as to be close to a square as much as possible. Thus, the two-dimensionally divided block of the update portion can be made large, and the reference to a portion repeatedly referenced in the course of the computation of a matrix product can be stored in a cache and can be comparatively effectively used.

For this purpose, after each thread's share in the update of a matrix product is determined in the following procedure, parallel computation is executed.

5. The square root of the total number #THRD of threads is computed.

6. If this value is not an integer, the value is rounded up to nrow.

7. The number of two-dimensional division is designated as nrow.

8. If the number of one-dimensional division is assumed to be ncol, the minimum integer meeting the following conditions is found.

ncol×nrow≧#THRD

9. if(ncol*nrow==#thrd)then

execute update in parallel in each thread by dividing a matrix into ncol*nrow by one-dimensionally and equally dividing it by ncol and also by two-dimensionally and equally dividing it by nrow, and else

update #THRD portions in parallel by dividing a matrix into ncol*nrow by one-dimensionally and equally dividing it and also by two-dimensionally and equally dividing it by nrow in such a way as (1,1), (1,2), (1,3), . . . (2,1), (2,2), (2,3), . . . . Then, generally the remaining is made to be a rectangle with a long horizontal side. Then, execute a parallel process again by two-dimensionally and equally dividing the rectangle and dividing an update portion in such a way that load can be equally shared by all threads and endif

Solver Portion

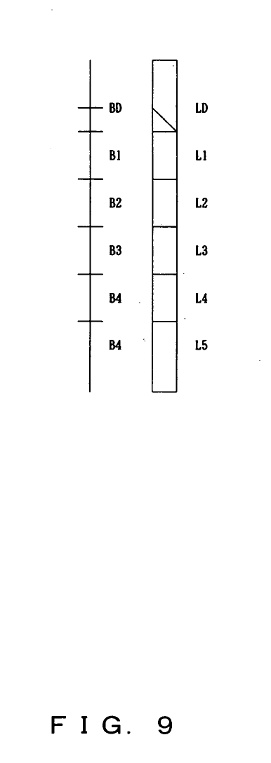

FIG. 9 shows the update of subblocks other than a diagonal portion.

The result of LU decomposition is stored in each node in a distributed and allocated state. Each node stores blocks with a comparatively small width in a state where LU decomposition has been applied to a matrix.

Forward substitution and backward substitution are applied to this small block, which is transferred to its adjacent node to which a subsequent block belongs, and is processed. In this case, a portion whose solution has been updated is transferred.

In actual forward substitution and backward substitution, a parallel update is executed by one-dimensionally and equally dividing a rectangular portion excluding a long diagonal block portion.

Firstly, one thread solves the following equation:

LD×BD=BD

By using this information, all threads update B in parallel as follows:

Bi=Bi−Li×BD

A portion modified by this update of one cycle is transferred to its adjacent node.

After forward substitution is completed, backward substitution is executed in such a way as to just reversely follow the procedure in which processing has been so far transferred to a node.

Actually, a portion arranged in each node of the original matrix is cyclically processed. This corresponds to replacing column blocks and converting the matrix into another matrix. This is because in the course of LU decomposition, a pivot can be extracted from any column of an un-decomposed portion. It corresponds to solve for y by converting APP⁻¹x=b by y=P⁻¹x. In this case, by re-arranging the solved y, x can be computed.

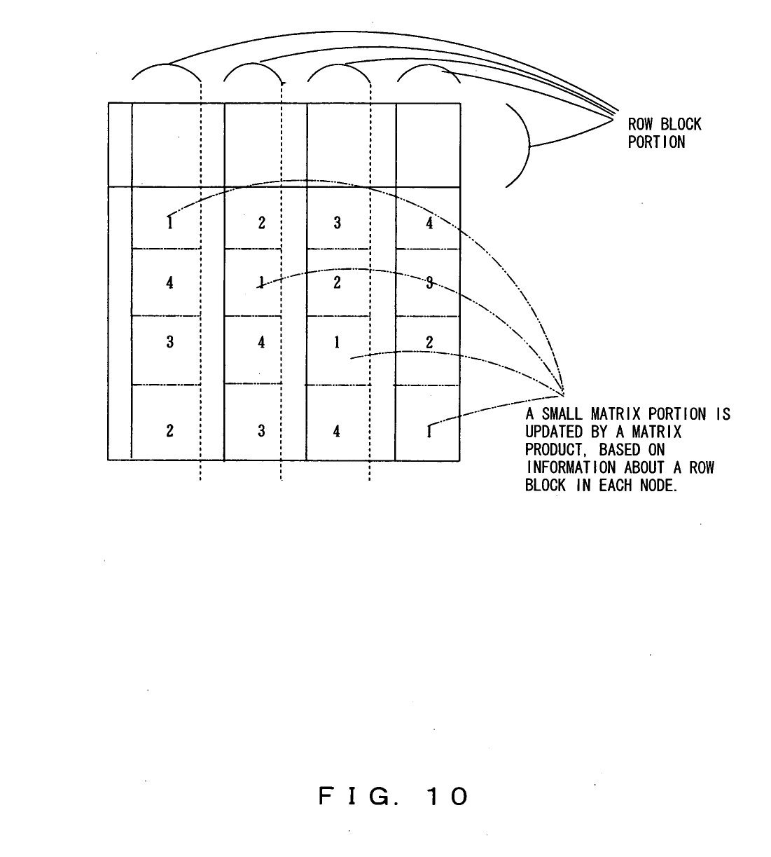

FIGS. 10 through 12 show the update process of row blocks.

After the computation of column blocks is completed, the arrangement of the currently computed portion is restored to the original one obtained by two-dimensionally dividing the matrix. In this case, data in the two-dimensionally divided form is stored in each node. After rows are replaced based on information about the replacement of rows, row blocks are updated.

The update is sequentially conducted by transmitting a column block portion that exists in each node to its adjacent node along a ring simultaneously with computation. This can be realized by providing another buffer. Although in this area, each node redundantly stores a diagonal block, this is also transferred together with the column block portion. The amount of data of portions other than a diagonal block is large and they are transferred simultaneously with computation. However, the transfer time cannot be recognized.

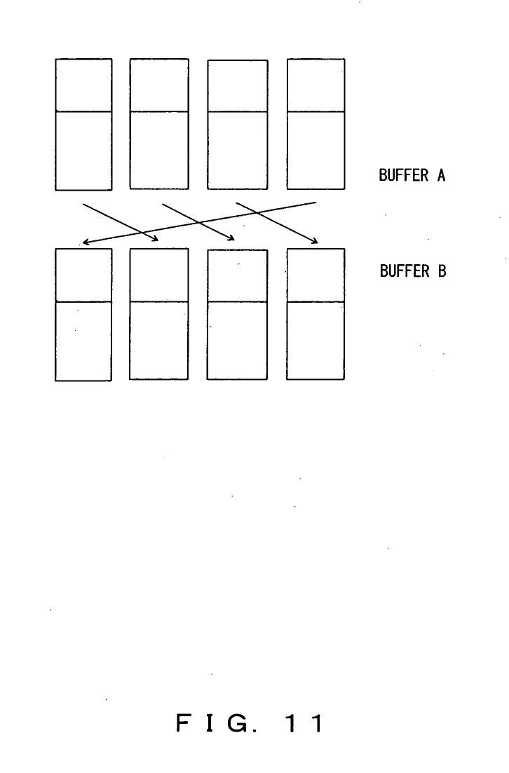

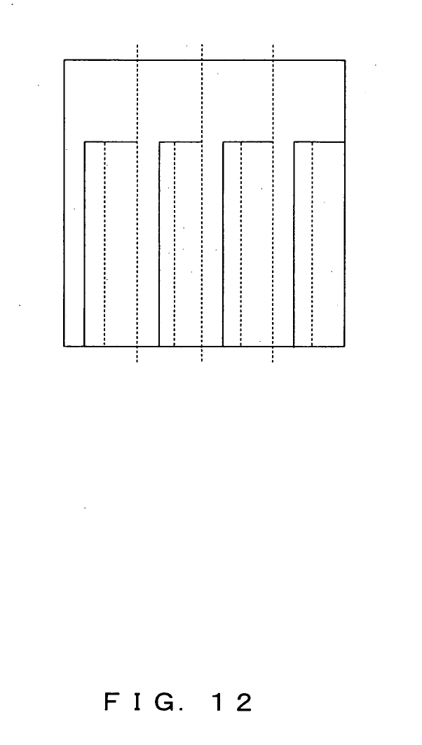

According to FIG. 11, data is transferred from a buffer A to a buffer B. In subsequent timing, data is transmitted along a node ring from buffer B to buffer A. Thus, data is transmitted by switching the buffer. Furthermore, in FIG. 12, after the update, the same process is repeatedly applied to a block obtained by reducing the size of a square matrix excluding column and row blocks.

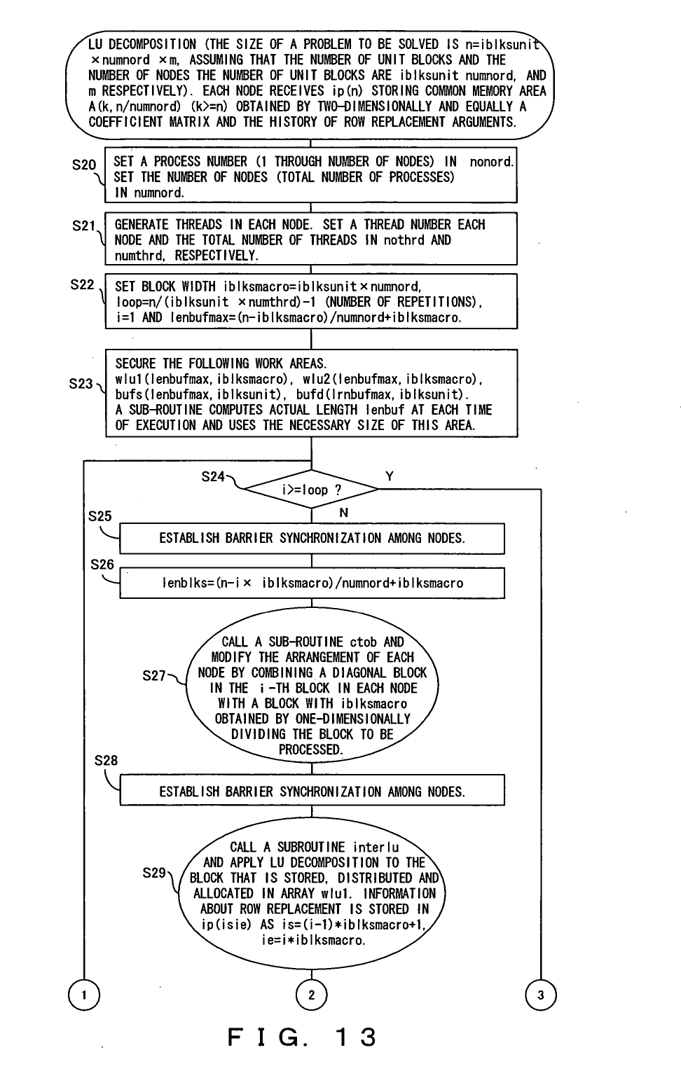

FIGS. 13 through 26 are flowcharts showing the process of the preferred embodiment of the present invention.

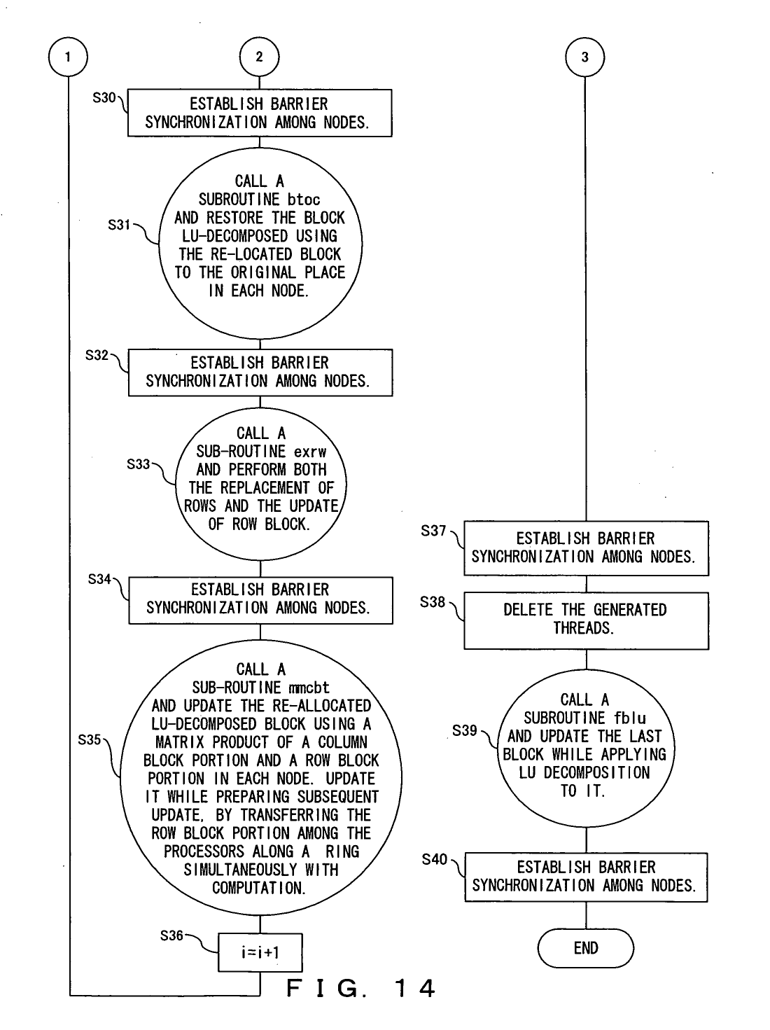

FIGS. 13 and 14 are the flowcharts of a sub-routine pLU. This sub-routine is a call program, and it executes processes in parallel by calling after generating one process in each node.

Firstly, LU decomposition is executed by designating the unit number of blocks, iblksunit, the number of nodes, numnord, and the size n of a problem to be solved, ibksunit×numnord×m (m: the unit number of blocks in each node), . The sub-routine receives a common memory area A(k,n/numnord) (k≧n) in which a coefficient matrix A is two-dimensionally and equally divided and is allocated to each node, and ip (n) storing replacement history as arguments. In step S20, a process number (1—number of nodes) is set in nonord, and the number of nodes (total number of processes) is set in numnord. In step S21, threads are generated in each node. Then, a thread number (1—number of threads) and the total number of threads are set in nothrd and numthrd, respectively. In step S22, the set width of a block iblksmacro=iblksunit×numnord, and the number of repetition loop=n(iblksunit×numthrd)−1 are computed. Furthermore, i=1 and lenbufmax=(n−iblksmacro)/numnord+iblksmacro are set.

In step S23, work areas for

wlul (lenbufmax, illksmacro),

wlu2 (lenbufmax, iblksmacro),

bufs (lenbufmax, iblksunit), bufd(lenbufmax, iblksunit) are secured. Every time the sub-routine is executed, only the necessary portion of this area is used by computing the actual length lenbuf.

In step S24, it is determined whether i≧loop. If the determination in step S24 is yes, the process proceeds to step S37. If the determination in step S24 is no, in step S25, barrier synchronization is established among nodes. Then, in step S26, lenblks=(n−1×iblksmacro)/numnord+iblksmacro is computed. In step S27, a sub-routine ctob is called, and the arrangement in each node is modified by combining the i-th diagonal block with a width iblksunit in each node with a block with a width iblksmacro obtained by one-dimensionally and equally dividing the block to be processed. In step S28, barrier synchronization is established among nodes. In step S29, a sub-routine interlu is called, is stored in an array wlu1, and LU decomposition is applied to the distributed and re-allocated block. Information about the replacement of rows is stored in ip (is:ie) as is=(i−1)*iblksmacro+1, ie=i*iblksmacro.

In step S30, barrier synchronization is established among nodes. In step S31, a sub-routine btoc is called, and a re-allocated block to which LU decomposition has been applied is returned to the original storage place of each node. In step S32, barrier synchronization is established among nodes. In step S33, a sub-routine exrw is called, and the replacement of rows and the update of row blocks are executed. In step S34, barrier synchronization is established among nodes. In step S35, a sub-routine mmcbt is called, and the re-allocated block to which LU decomposition has been applied is updated using the matrix product of a column block portion (stored in wlul) and a row block portion. The column block portion is transferred among processors along the ring simultaneously with computation, and is updated while preparing for subsequent update. In step S36, i=i+1 is executed, and the process to returns to step S24.

In step S37, barrier synchronization is established, and in step S38, the generated threads are deleted. In step S39, a sub-routine fblu is called, and update is made while executing the LU decomposition of the last block. In step S40, barrier synchronization is established and the process terminates.

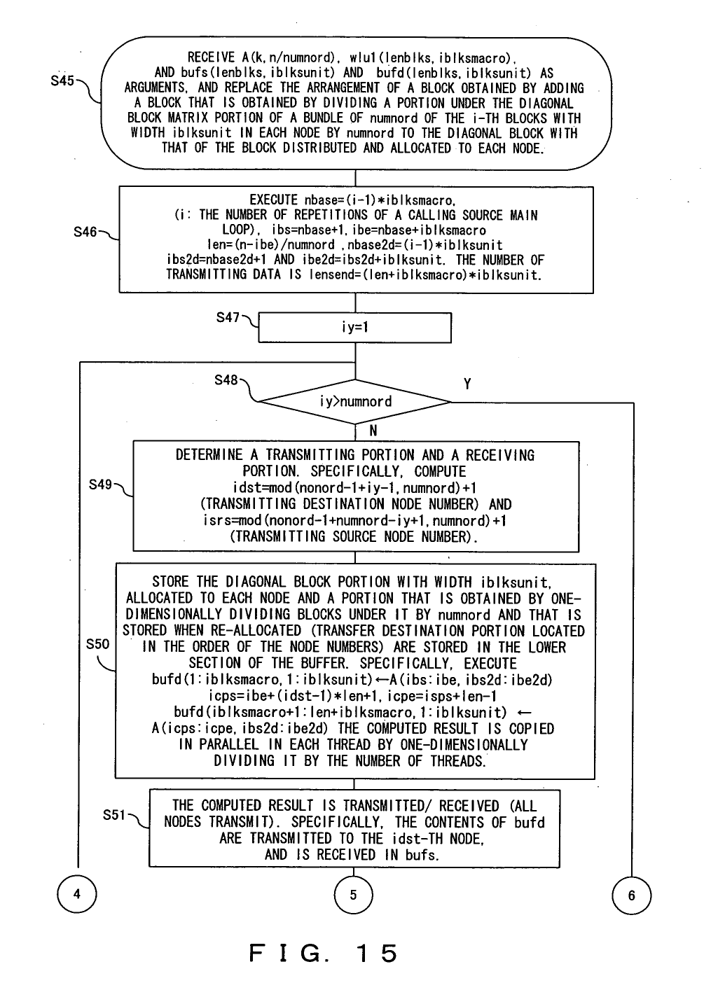

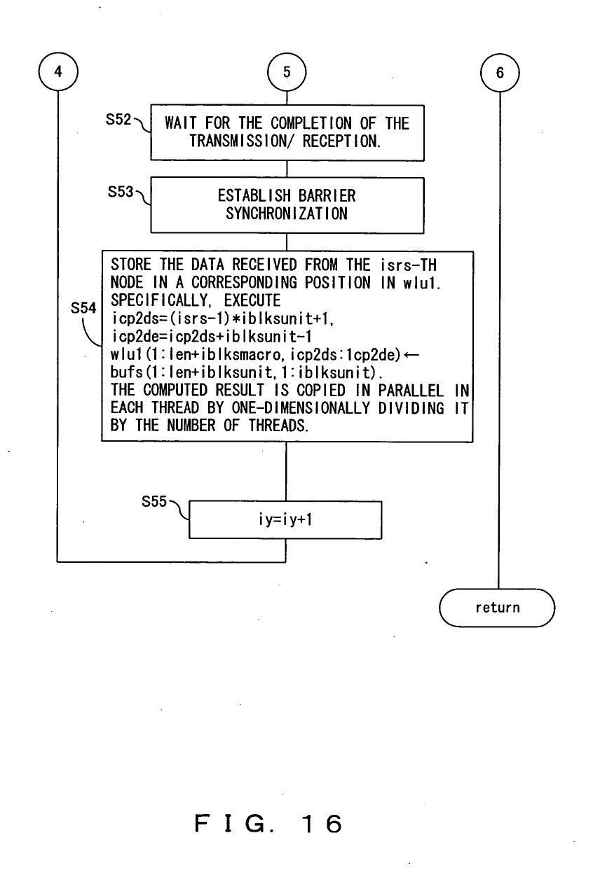

FIGS. 15 and 16 are the flowcharts of a sub-routine ctob.

In step S45, sub-routine ctob receives A(k,n/numnord), wlul (lenblks, iblksmacro), bufs (lenblks, iblksunit) and bufd (lenblks, iblksunit) as arguments, and the arrangement of a block obtained by adding a block that is obtained by dividing a portion under the diagonal block matrix portion of a bundle of numnord of the i-th blocks with width iblksunit in each node by numnord, to the diagonal block is replaced with that of the block distributed and allocated to each node, using transfer.

In step S46, nbase=(i−1)*iblksmacro (i: number of repetition of a call source main loop), ibs=nbase+1, ibe=nbase; iblksmacro, len=(n−ibe)/numnord, nbase2d=(i−1)*iblksunit and ibs2d=nbase2d+1, ibe2d=ibs2d+iblksunit are executed. In this case, the number of transmitted data is lensend=(len+iblksmacro)*iblksunit. In step S47, iy=1 is assigned, and in step S48 it is determined whether iy>numnord. If the determination in step S48 is yes, the process gets out of the sub-routine. If the determination in step S48 is no, in step S49, a transmitting portion and a receiving portion are determined. Specifically, idst=mod(nornord−1+iy−1, numnord)+1 (transmitting destination node number) and isrs=mod(nonnord−1+numnord−iy+1, numnord)+1 (transmitting source node number) are executed. In step S50, the diagonal block portion with width iblksunit, allocated to each node and a block that is obtained by one-dimensionally dividing its block located under it by numnord and that is stored when it is re-allocated (transfer destination portion located in the ascending order of the number of nodes) are stored in the lower part of the buffer. Specifically, bufd(1:iblksmacro,1:iblksunit)→A(ibs:ibe, ibs2d:ibe2 d), icps−ibe+(idst−1)+len+1, icpe=isps=isps+len−1 and bufd (iblksmacro+1:len+iblksmacro, l:iblksumit)→A(icp s:icpe, ibs2d:ibe2d) are executed. The computed result is copied in parallel to each thread by one-dimensionally dividing it into the number of threads.

In step S51, the transmission/reception of the computed result is conducted among all nodes. Specifically, each node transmits the contents of bufd to the idst-th node, and the idst-th node receives it in bufs. In step S52, each node waits for the completion of the transmission/reception. In step S53, each node establishes barrier synchronization, and in step S54, each node stores the data received from the isrs-th node in the corresponding position of wlul. Specifically, each node executes icp2ds=(isrs−1)*iblksunit+1, icp2de=icp2ds; iblksunit−1 and wlu1 (1:1en+iblkacro, icp2ds:icp2de)→bufs (1:len+iblksunit, 1:iblksunit). Specifically, each node executes parallel copy in each thread by one-dimensionally dividing the data by the number of threads. In step S55, iy=iy+1 is assigned, and the process returns to step S48.

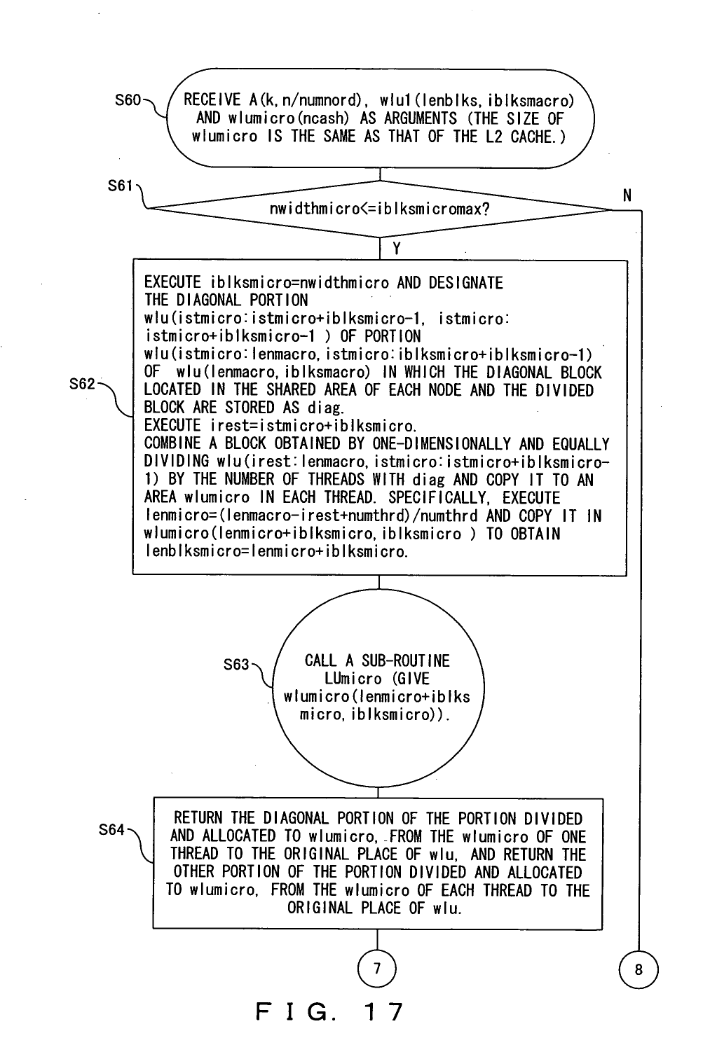

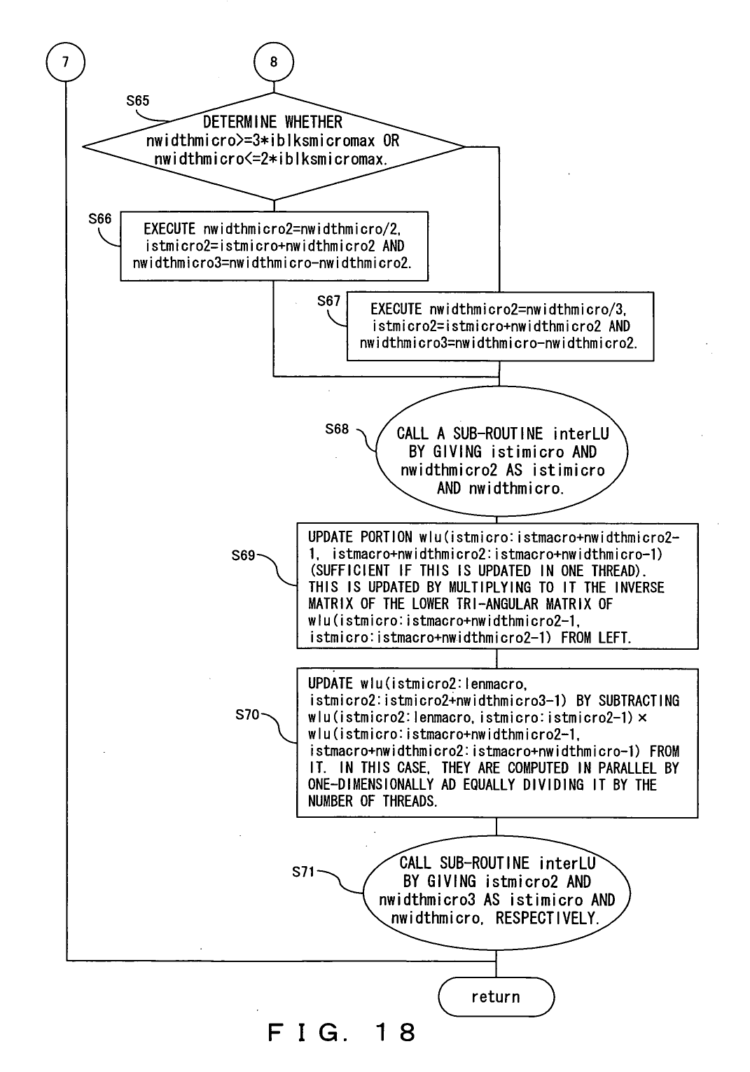

FIGS. 17 and 18 are the flowcharts of a sub-routine interLU.

In step S60, A(k,n/numnord), wlul(lenblks, iblksmacro) and wlumicro (ncash) are received as arguments. In this case, the size of wlumicro (ncash) is the same as that of an L2 cache (cache at level 2) and wlumicro (ncache) is secured in each thread. A diagonal block with a width iblksmacro, to be LU-decomposed and one of blocks obtained by one-dimensionally dividing a block located under it are stored in an area wlul in each node. Both pivot search and the replacement of rows are executed to the LU decomposition in parallel, using inter-node transfer. This sub-routine is recursively called. As the calling deepens, the block width in LU decomposition decreases. If this block is LU-decomposed in parallel in each thread, another sub-routine for executing the LU-decomposition in parallel in each thread is called up when the block width computed by each thread becomes equal to or less than the size of the cache.

In the parallel thread processing of a comparatively small block, this diagonal matrix portion is shared by each thread and the block is copied and processed so that it can be processed in an area wlumicro smaller than the size of the cache of each thread by one-dimensionally and equally dividing a portion located below the diagonal block. istmicro represents the leading position of a small block, and it is initially set to 1. nidthmicro represents the width of a small block and at first is set to the width of the entire block. iblksmicromax represents the maximum value of a small block, and reduces the block width when the block width exceeds it (for example, to 80 columns) . nothrd and numthrd represent a thread number and the number of threads, respectively, and they are stored in a one-dimensional array ip(n) shared by each node as replacement information.

In step S61, it is determined whether nwidthmicro≦iblksmicromax. If the determination instep S61 is yes, in step S62, by executing iblksmicro=nwidthmicro as to a diagonal block in an area of each node, where the load is shared and portion wlu (istmicro:lenmarco, istmicro: iblksmicro+iblksmicro−1) of wlu (lenmacro, iblksmacro) in which a divided block is stored, diagonal portion wlu (itmicro:istmicro+iblksmicro−1, istmicro:istmicro;iblksmicro−1) is designated as a diagonal block. By executing irest=istmicro+iblksmicro, a portion obtained by one-dimensionally and equally dividing wlu(irest:lenmarco, itmicro:istmicro+iblksmicro−1) is combined with the diagonal block, and the combination is copied to the area wlumicro of each thread. Specifically, lenblksmicro=lenmicro+iblksmicro is obtained by executing lenmicro=(lenmacro−irest+numthrd)/numthrd and copying wlumicro (lenmicro+iblksmicro, iblksmicro). Then, in step S63, a sub-routine Lumicro is called. Then, wlumicro (linmicro;iblksmicro, iblksmicro) is given. In step S64, the diagonal portion of the portion divided and allocated to wlumicro is returned from the wlumicro of one thread to the original place of wlu, and the other portion of the portion divided and allocated to wlumicro is returned from the wlumicro of each thread to the original place of wlu. Then, the process gets out of the sub-routine.

If the determination in sep S61 is no, in step S65 it is determined whether nwidthmicro≧3*iblksmicromax or nwidthmicro≦2*iblksmicromax. If the determination in sep S65 is yes, in step S66 nwidthmicro2=nwidthmicro/2, istmicro2=istmicro+nwidthmicro2 and nwidthmicro3=nwidthmicro−nwidthmicro2 are executed and the process proceeds to step S68. If the determination in sep S65 is no, in step S67 nwidthmicro2=nwidthmicro/3, istmicro2=istmicro+nwidthmicro2 and nwidthmicro3=nwidthmicro−nwidthmicro2 are executed and the process proceeds to step S68. In step S68, istmicro calls the sub-routine by giving nwidthmicro2 as nwidthmicro2 to the sub-routine interLU as nwidthmicro.

In step S69, portion wlu(ismicro:istmacro+nwidthmicro−1) is updated. It is sufficient to update this in one thread. In this case, portionwlu(ismicro:istmacro+nwidthmicro−1) is updated by multiplying to it the inverse matrix of the lower triangular matrix of wu(istmicro:istmacro+nwidthmicro2−1, istmicro:istmacro+nwidthmicro2−1) from left. In step S70, wlu(istmicro2:lenmacro, istmicro2:istmicro2+nwidthmicro3−1) is updated by subtracting wlu(istmicro2:lenmacro, istmicro:istmicro2−1)×wlu(istmicro:istmacro+nwidthmi cro2−1,istmacro+nwidthmicro2:istmacro+nwidthmicro−1) from it. In this case, parallel computation is executed by one-dimensionally and equally dividing it by the number of threads. In step S71, the sub-routine interLU is called by giving istmicro2 and nwidthmicro3 as istmicro and nwidthmicro, respectively, and the sub-routine terminates.

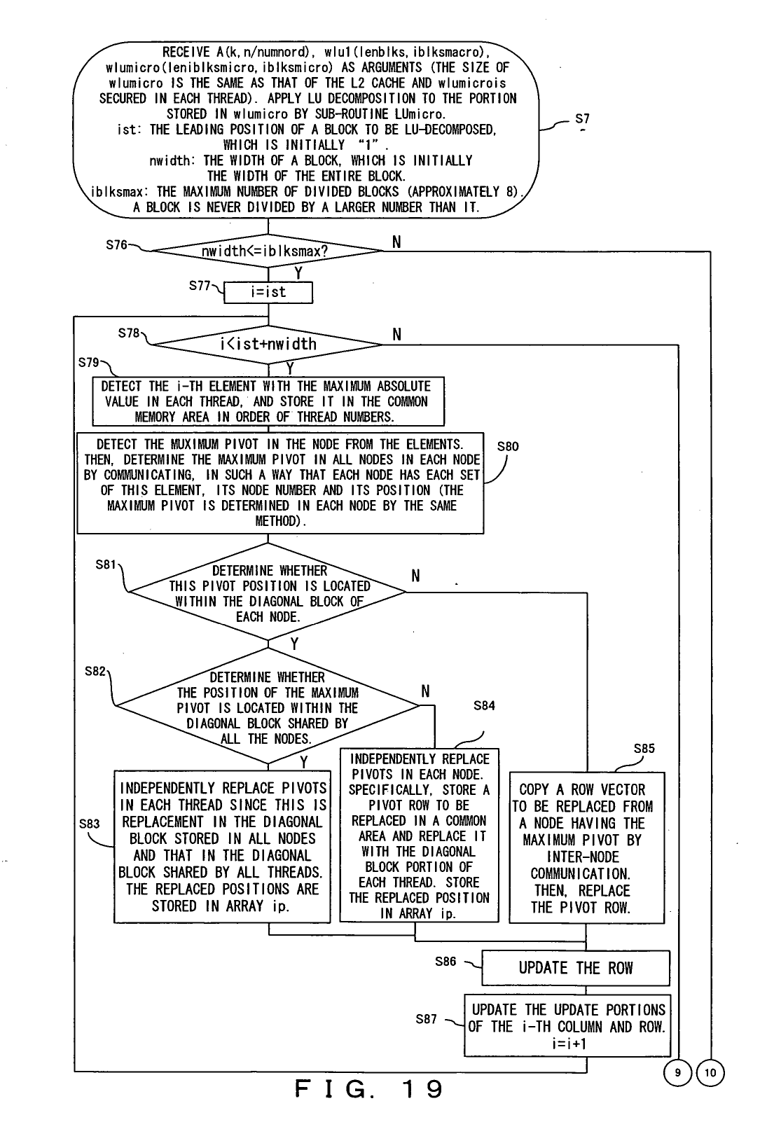

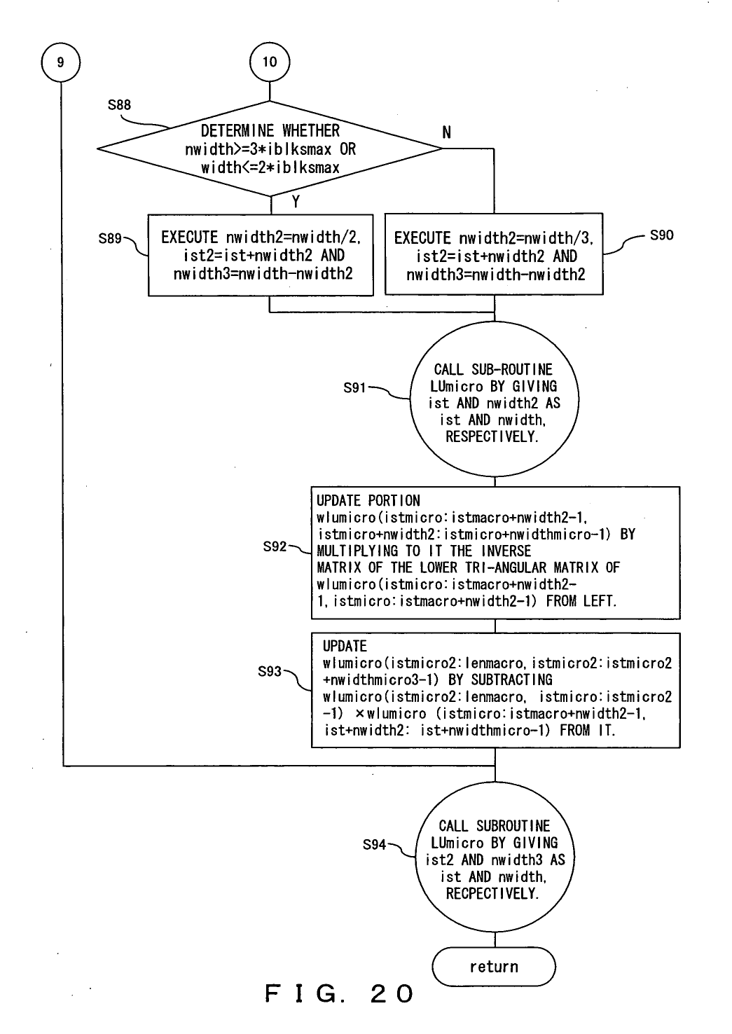

FIGS. 19 and 20 are the flowcharts of a sub-routine LUmicro.

In step S75, A(k,n/numnord), wlul (lenblks, iblksmacro) and wlumicro (leniblksmicro, iblksmicro) are received as arguments. In this case, wlumicro is secured in each thread whose size is the same as that of an L2 cache. In this routine, the LU decomposition of a portion stored in wlumicro is executed. ist represents the leading position of a block to be LU-decomposed, and it initially is 1. nwidth represents block width, and it initially is the entire block width. iblksmax represents the maximum number of blocks (approximately 8) and a block is never divided into more than that number. wlumicro is given to each thread as an argument.

In step S76 it is determined whether nwidth<iblksmax. If the determination in step S76 is no, the process proceeds to step S88. If the determination in step S76 is yes, in step S77, i=ist is executed, and in step S78 it is determined whether i<istnwidth. If the determination in step S78 is no, the process gets out of the subroutine. If the determination in step S78 is yes, in step S79, the i-th element with the maximum absolute value is detected in each thread and is stored in a common memory area in the order of thread numbers. In step S80, the maximum pivot in the node is detected from the elements. Then, the maximum pivot in all nodes is determined in each node by communicating, in such a way that each node has each set of this element, its node number and its position, and the maximum pivot in all nodes is determined in each node. This maximum pivot is determined by the same method in each node.

In step S81, it is determined whether this pivot position is in a diagonal block in each node. If the determination in step S81 is no, the process proceeds to step S85. If the determination in step S81 is yes, in step S82 it is determined whether the position of the maximum pivot is in a diagonal block shared by each thread. If the determination in step S82 is yes, in step S83, pivots are independently replaced in each thread since this is replacement in the diagonal block stored in all nodes and that in the diagonal block shared by all threads. The replaced positions are stored in array ip, and the process proceeds to step S86. If the determination in step S82 is no, in step S84, the pivot in such a diagonal block is independently replaced with the maximum pivot in each node. In this case, a pivot row to be replaced is stored in the common area and is replaced with the diagonal block portion of each thread. The replaced position is stored in array ip and the process proceeds to step S86.

In step S85, a row vector to be replaced is copied from a node with the maximum pivot by inter-node communication. Then, the pivot row is replaced. In step S86, the row is updated, and in step S87, the update portions of the i-th column and row are updated. Then, i=i+1 is executed and the process returns to step S78.

In step S88, it is determined whether nwidth≧3*iblksmax or nwidth≦2*iblksmax. If the determination in step S88 is yes, in step S89, nwidth=nwidth/2 and ist2=ist+nwidth2 are executed and the process proceeds to step S91. If the determination in step S88 is no, in step S90, nwidth2=nwidth/3, ist2=ist+nwidth2 and nwidth3=nwidth−nwidth2 are executed, and the process proceeds to step S91. In step S91, the sub-routine LUmicro is called by giving ist and nwidth2 as ist and nwidth, respectively, to the sub-routine as an argument. In step S92, portion wlumicro(istmicro:istmacro+nwidth2−1, istmicro+nwidt h2:istmicro+nwidthmicro−1) is updated. In this case, wlumicro(istmicro:istmacro+nwidth2−1, istmicro+nwidth2:istmicro+nwidthmicro−1) is updated by multiplying to it the inverse matrix of the lower triangular matrix of wlumicro(istmicro:istmacro+nwidthmicro2−1, istmicro: istmacro+nwidth2−1) from left. In step S93, wlumicro(istmicro2:lenmacro,istmicro2:istmicro2+nwi dthmicro3−1) is updated by subtracting wlumicro(istmicro2:lenmacro,istmicro:istmicro2−1)×wlumicro(istmicro:istmacro+nwidth2−1, ist+nwidth2:ist+nwidthmicro−1) from it. In this case, In step S94, the sub-routine interLU is called by giving ist2 and nwidth3 as ist and nwidth, respectively, and the process gets out of the sub-routine.

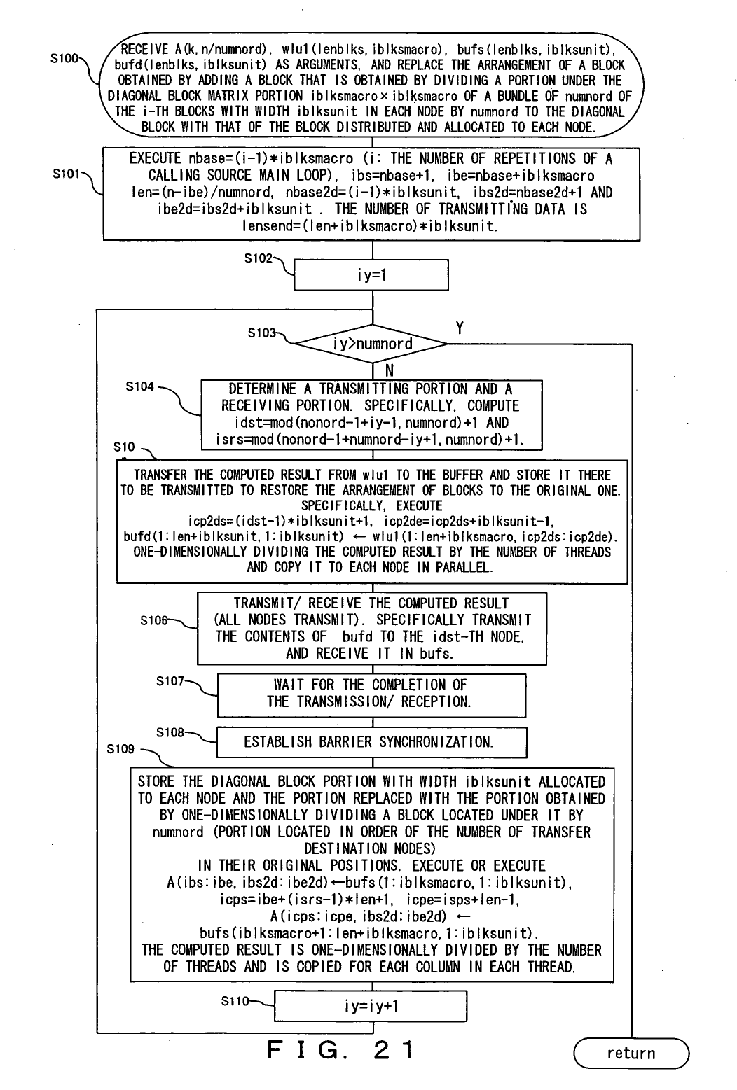

FIG. 21 is the flowchart of a subroutine btoc.

In step S100, A(k, n/numnord), wlul(lenblks, iblksmacro), bufs(lenblks, iblksunit), bufd(lenblks, iblksunit) are received as arguments, and the arrangement of a block obtained by adding a block that is obtained by dividing a portion under the diagonal block matrix portion iblksmacro×iblksmacro of a bundle of numnord of the i-th blocks width iblksunit in each node by numnord to the diagonal block, are replaced with that of the block distributed and allocated to each node, using transfer.

In step S101, nbase=(i−1)*iblksmacro (i=number of repetitions of a calling source main loop), ibs=nbase+1, ibe=nbase+iblksmacro, len=(n−ibe)/numnord, nbase2d=(i−1)*iblksunit, ibs2d=nbase2d+1 and ibe2d=ibs2d+iblksunit are executed, and the number of transmitting data is lensend=(len+iblksmacro)*iblksunit.

In step S102, iy=1 is executed, and in step S103 it is determined whether iy>numnord. If the determination in step S103 is yes, the process gets out of the sub-routine. If the determination in step S 103 is no, in step S104, a portion to be transmitted and a portion to be received are determined. Specifically, idst=mod(nonord−1+iy−1, numnord)+1, isrs=mod(nonord−1+iy−1, numnord)+1, isrs=mod(nonord−1numnord−iy+1, numnord)+1 are executed. In step S105, the computated result is transferred from wlul to a buffer and is stored there to be transmitted to restore the arrangement of blocks to the original one. A corresponding part is transmitted to the idst-th node. Specifically, icp2ds=(idst−1)*iblksunit+1, icp2de=icp2ds+iblksunit−1, bufd(1:len+iblksunit, 1:iblksunit)→wlul (1:len+iblksmacro, icp2ds: icp2de) are executed. The computed result is one-dimensionally divided by the number of threads and is copied to each node in parallel.

In step S106, the computed result is transmitted/received in all nodes. The contents of bufd are transmitted to the idst-th node and are received in bufs. In step S107, the process waits for the completion of the transmission/reception, and in step S108, barrier synchronization is established. In step S109, the diagonal block portion with width iblksunit allocated to each node and the portion replaced with the portion obtained by one-dimensionally dividing a block located under it by numnord (portion located in the order of the number of transfer destination nodes) are stored in their original positions. A(ibs:ibe,ibs2d:ibe2d)→bufs (1:iblksmacro, 1:iblksuni t), icps=ibe+(isrs−1)*len+1, icpe=isps+len−1, A(icps*icpe,ibs2d:ibe2d)→bufs (iblksmacro+1:iblksmac ro, 1:iblksmacro, 1:iblksunit) are executed. The computed result is one-dimensionally divided by the number of threads and is copied for each column in each thread.

In step S110, iy=iy+1 is executed, and the process returns to step S103.

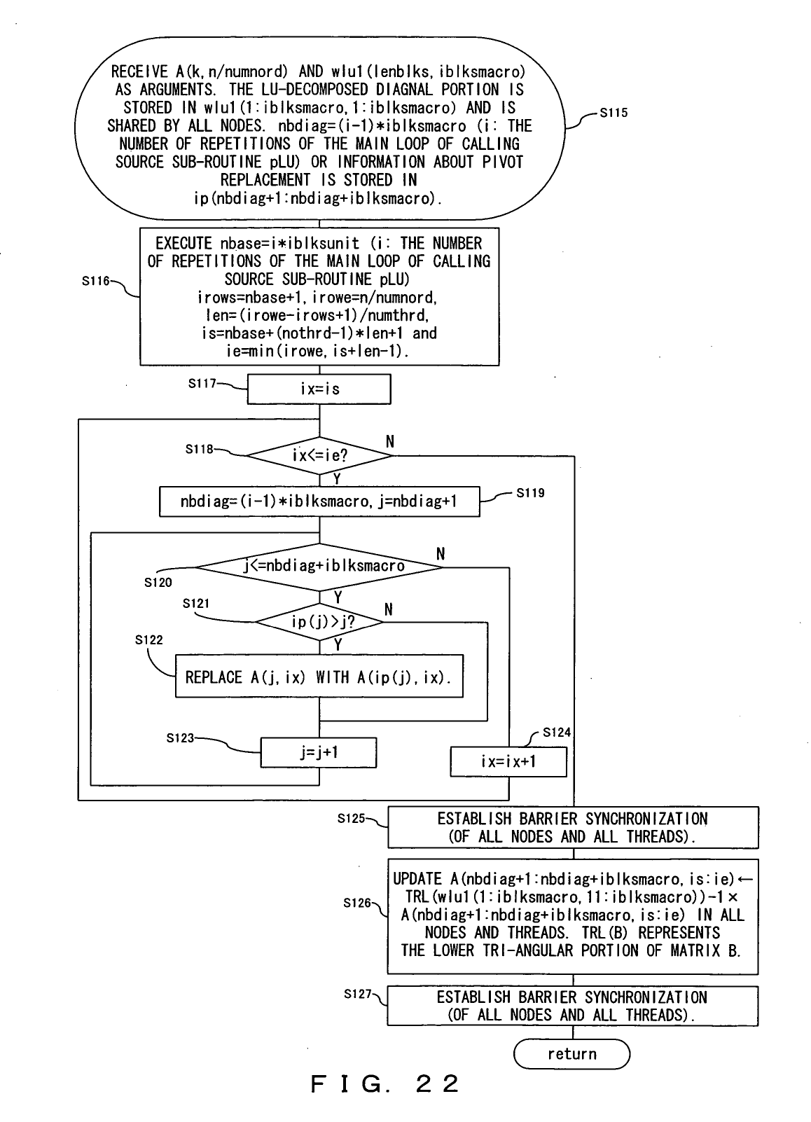

FIG. 22 is the flowchart of a sub-routine exrw.

This sub-routine is used to update the replacement of rows and the update of row blocks.

In sep S115, A(k,n/numnord) and wlul (lenblks, iblksmacro) are received as arguments. The LU-decomposed diagonal portion is stored in wlul(1:iblksmacro, 1:iblksmacro) and is shared by all nodes. nbdiag=(i−1)*iblksmacro is executed. i represents the number of repetitions of the main loop of a calling source subroutine pLU. Information about pivot replacement is stored in ip(nbdiag+1:nbdiag+iblksmacro).

In step S116, nbase=i*iblksunit (i: the number of repetitions of the main loop of a calling source subroutine pLU), irows=nbase+1, irowe=n/numnord, len=(irowe−irows+1)/numthrd, is=nbase+(nothird−1)*len+1 and ie=min(irowe, is+len−1) are executed. In step S117, ix=is is executed.

In step S118, it is determined whether is≦ie. If the determination in step S118 is no, the process proceeds to step S125. If the determination in step S118 is yes, in step S119, nbdiag=(i−1)*iblksmacro and j=nbdiag+1 are executed, and in step S120, it is determined whether j≦nbdiag+iblksmacro. If the determination in step S120 is no, the process proceeds to step S124. If the determination in step S120 is yes, in step S121 it is determined whether ip(j)>j. If the determination in step S121 is no, the process proceeds to step S123. If the determination in step S121 is yes, in step S122, A(j, ix) is replaced with A(ip(j),ix), and the process proceeds to step S123. In step S123, j=j+1 is assigned, and the process returns to step S120.

In step S124, ix=ix+1 is executed, and the process returns to step S118.

In step S125, barrier synchronization (all nodes, all threads) is established. In step S126, A(nbdiag+1nbdiag+iblksmaco, is:ie)→TRL(wlul(i:iblksm acro,1:iblksmacro))×A(nbdiag+1:nbdiag+iblksmacro, is: ie) is updated in all nodes and in all threads. In this case, TRL(B) represents the lower tri-angular matrix portion of a matrix B. In step S127, barrier synchronization (all nodes, all threads) is established and the process gets out of the sub-routine.

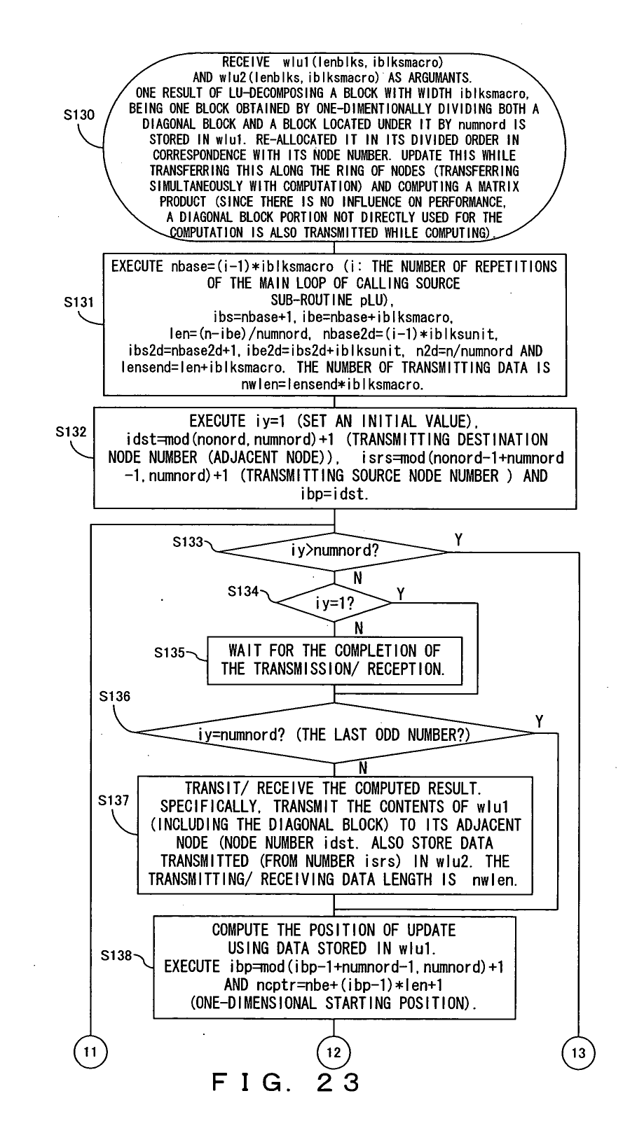

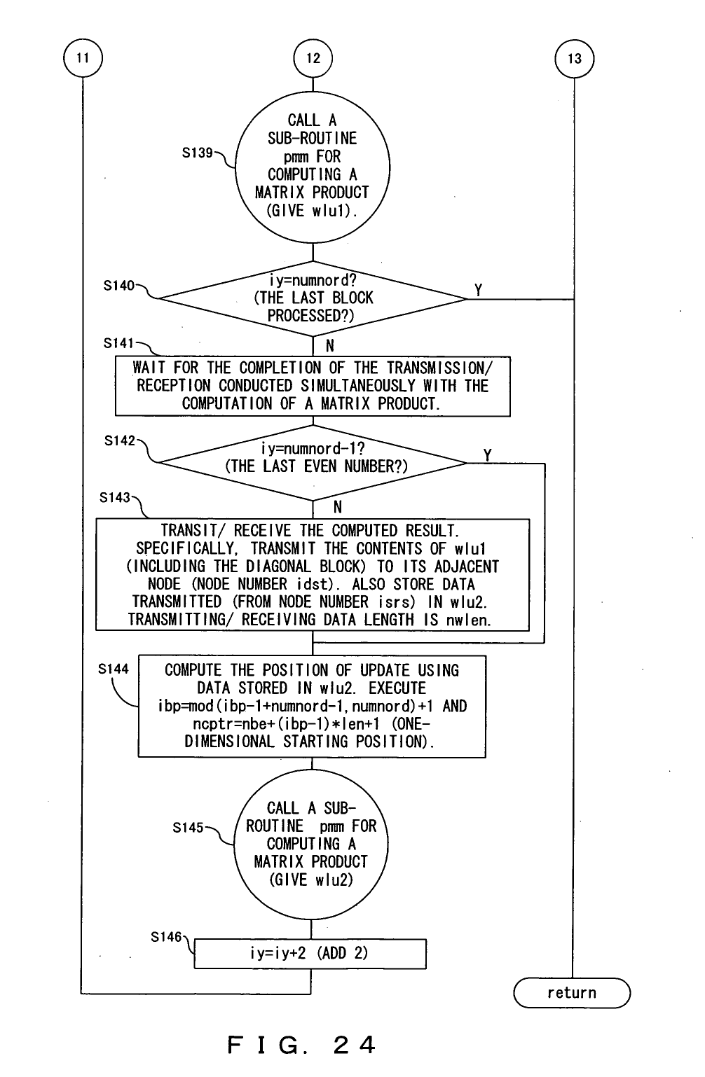

FIGS. 23 and 24 are the flowcharts of a subroutine mmcbt.

In step S130, A(k,n/numnord), wlul (lenblks, iblksmacro), wlu2 (lenblks, blksmacro) are received as arguments. The result of LU-decomposing a block with width iblksmacro, being one block obtained by one-dimensionally dividing both a diagonal block and a block located under it by numnord is stored in wlul. It is re-allocated to nodes in its divided order in correspondence with its node number. This is updated while transferring this along the ring of nodes (transferring simultaneously with computation) and computing a matrix product. Since there is no influence on performance, a diagonal block portion not directly used for the computation is also transmitted while computing.

In step S131, nbase=(i−1)*iblksmacro (i: the number of repetitions of the main loop of a calling source subroutine pLU), ibs=nbase+1, ibe=nbase+iblksmacro, len=(n−ibe)/numnord, nbase2d(i−1)*iblksunit, ibs2d=nbase2d+1, ibe2d=ibs2d+iblksunit, n2d=n/numnord and lensend=len:iblksmacro are executed, and the number of transmitting data is nwlen=lensend*iblksmacro.

In step S132, iy=1 (setting an initial value), idst=mod(nonord, numnord)+1 (transmitting destination node number (adjacent node)), isrs=mod(nonnord−1+numnord−1,numnord)+1 (transmitting source node number) and ibp=idst are executed.

In step S133, it is determined whether iy>numnord. If the determination in step S133 is yes, the process gets out of the sub-routine. If the determination in step S133 is no, in step S134 it is determined whether iy=1. If the determination in step S134 is yes, the process proceeds to step S136. If the determination in step S134 is no, in step S135, the process waits for the completion of the transmission/reception. In step S136, it is determined whether iy=numnord (the last odd number). If the determination in step S136 is yes, the process proceeds to step S138. If the determination in step S136 is no, in step S137, the transmission/reception of the computed result is conducted. The contents of wlul (including a diagonal block) are transmitted to its adjacent node (node number idst), and data transmitted to wlu2 (from node number isrs) is stored. In this case, the transmitting/receiving data length is nwlen.

In step S138, the position of update using data stored in wlul is computed. ibp=mod(ibp−1+numnord−1,numnord)+1 and ncptr=nbe+(ibp−1)*len+1 (one-dimensional starting position) are executed. In step S139, a sub-routine for computing a matrix product is called. At this time, wlul is given. In step S140, it is determined whether iy=numnord (the last process is completed) . If the determination in step S140 is yes, the process gets out of the sub-routine. If the determination in step S140 is no, in step S141, the process waits for the completion of the transmission/reception conducted simultaneously with the computation of a matrix product operation. In step S142, it is determined whether iy=numnod−1 (the last even number). If the determination in step S142 is yes, the process proceeds to step S144. If the determination in step S142 is no, in step S143, the transmission/reception is conducted. Specifically, the contents of wlul (including the diagonal block) are transmitted to its adjacent node (node number idst). The data transmitted to wlul (from node number isrs) is stored. The transmitting/receiving data length is nwlen.

In step S144, the position of update using data stored in wlu2 is computed. Specifically, ibp=mo(ibp−1+numnord−1,numnord)+1 and ncptr=nbe+(ibp−1)*len+1 (one-dimensional starting position) are executed.

In step S145, a sub-routine pmm for computing a matrix product is called. At this time, wlu2 is given. In step S146, 2 is added and iy−iy+2 is assigned. Then, the process returns to step S133.

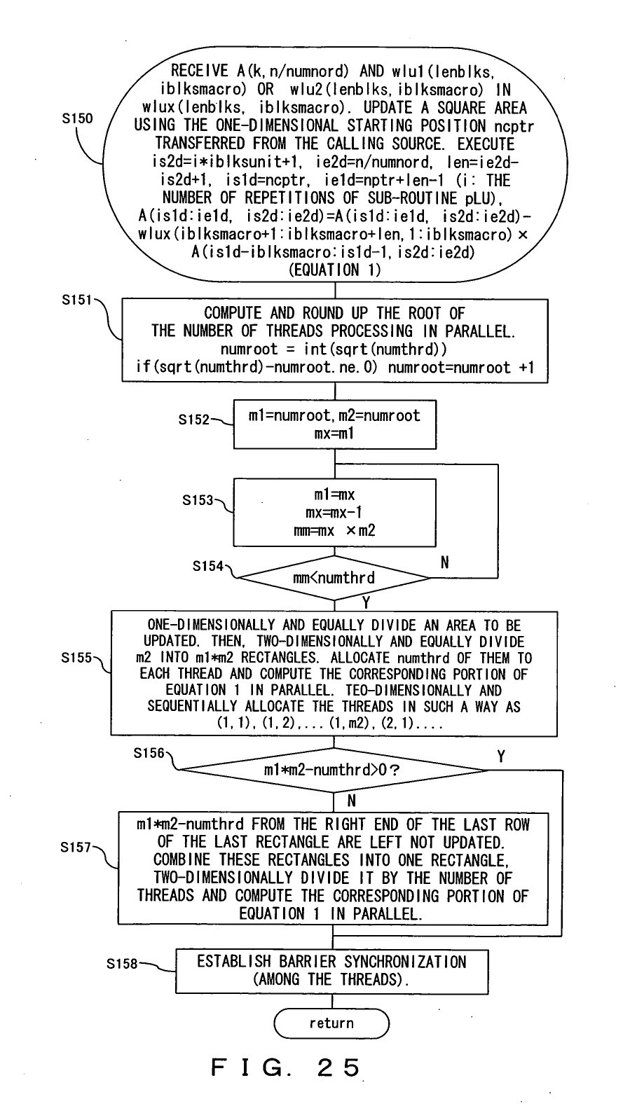

FIG. 25 is the flowchart of the sub-routine pmm.

In step S150, A(k,n/numnord), and wlul (lenblks, iblksmacro) or wlu2 (lenblks, iblksmacro) is received in wlux (lenblks, iblksmacro) . A square area is updated using one-dimensional starting position ncptr given by a calling source. is2d=i*iblksunit+1, ie2d=n/numnord, len=ie2d−is2d+1, isld=ncptr, ield=nptr+len−1 (i: the number pf repetitions of sub-routine pLU), A(isld:ield, is2d:ie2d)=A(isld:ield, is2d:ie2d)−wlu(i blksmacro+1:iblksmacro+len,1*iblksmacro)×A(isld−iblk smacro:isld−1,isld,is2d:ie2d)(equation 1) are executed.

In step S151, the root of the number of threads for processing blocks in parallel is computed and rounded up. numroot=int (sqrt (numthrd)) is executed. If sqrt(numthrd)−numroot is not zero, numroot=numroot+1 is executed. In this case, int means to drop the fractional portion of a number, and sqrt means a root. In step S152, m1=numroot, m2=numroot and mx=m1 are executed. In step S153, m1=mx, mx=mx−1 and mm=mxxm2 are executed. In step S154, it is determined whether mm<numthrd. If the determination in step S154 is no, the process returns to step S153. If the determination in step S154 is yes, in step S155, an area to be updated is one-dimensionally and equally divided by m1. Then, it is two-dimensionally divided by m2. Then, m1×m2 of rectangles are generated. numthrd of them are allocated to each thread and the corresponding portion of equation 1 are computed in parallel. The threads are two-dimensionally and sequentially allocated in such a way as (1,1), (1,2), . . . (1,m2), (2,1), . . . .

In step S156, it is determined whether m1*m2−numthrd>0. If the determination in step S156 is yes, the process proceeds to step S158. If the determination in step S156 is no, m1*m2−numthrd from the right end of the last row of the last rectangle are left not updated. Then, instep S157, this m1*m2−numthrd is combined into one rectangle and is two-dimensionally divided by the number of threads numthrd. Then, the corresponding portions of equation 1 are computed in parallel. Then, in step S158, barrier synchronization is established (among threads), and the process gets out of the sub-routine.

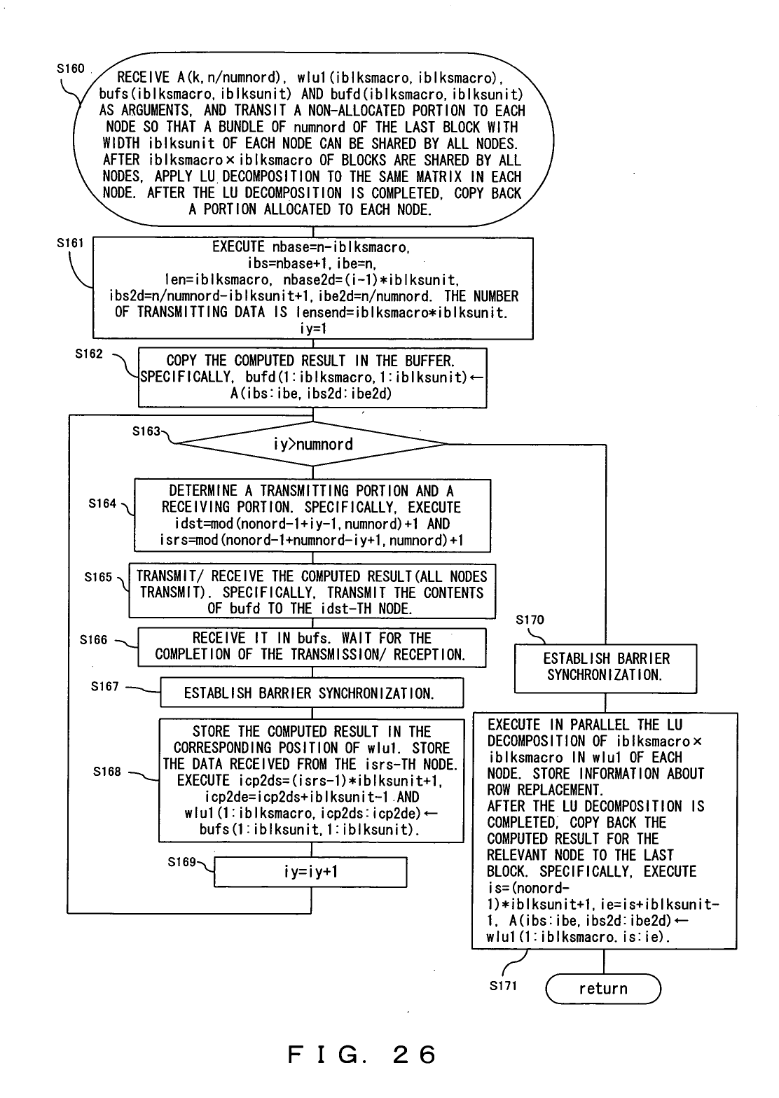

FIG. 26 is the flowchart of a sub-routine fblu.

In step S160, A(k,n/numnord), wlul(iblksmacro, iblksmacro), bufs(iblksmacro, iblksunit) and bufd(iblksmacro, iblksunit) are received as arguments, and a non-allocated portion is transmitted to each node so that a bundle of numnord of the last blocks with width iblksunit, of each node can be shared by all nodes. After iblksmacro×iblksmacro of blocks are shared by all nodes, LU decomposition is applied to the same matrix in each node. After the LU decomposition is completed, a portion allocated to each node is copied back.

In step S161, nbase=n−iblksmacro, ibs=nbase+1, ibe=n, len=iblksmacro, nbase2d=(i−1)*iblksunit, ibs2d=n/numnord−iblksunit+1 and ibe2d=n/numnord are executed. The number of transmitting data is lensend=iblksmacro*iblksunit and iy=1 is assigned.

In step S162, the computed result is copied to the buffer. Specifically, bufd(1:iblksmacro,1:iblksunit)→A(ibs:ibe,ibs2d:ibe2 d) is executed. In step S163, it is determined whether iy>numnord. If the determination in stepS163 is yes, the process proceeds to step S170. If the determination in stepS163 is no, in step S164, a transmitting portion and a receiving portion are determined. Specifically, idst=mod(nonord−1+iy−1,numnord)+1, isrs=mod(nonord−1+numnord−iy+1,numnord)+1 are executed. In step S165, the transmission/reception of the computed result is conducted in all nodes. The contents of bufd is transmitted to the idst-th node. In step S166, the data is received in bufs, and the process waits for the completion of the transmission/reception. In step S167, barrier synchronization is established, and in step S168, data transmitted from the isrs-th node is stored in the corresponding position of wlul. Icp2ds=(isrs−1)*iblksunit+1, icp2de=icp2ds+iblksunit−1, wlu(1:iblksmacro, icp2ds:icp2de) bufs (1:iblksunit, 1:iblksunit) are executed. In step S169, iy=iy+1 is executed, and the process returns to step S163.

In step S170, barrier synchronization is established, and in step S171, The LU decomposition of iblksmacro×iblksmacro is executed in parallel in each node. Information about row replacement is stored in ip. If the LU decomposition is completed, the computed result for the relevant node is copied back to the last block. Specifically, is=(nonord−1)*iblksunit+1, ie=is+iblksunit−1, A(ibs:ibe,ibs2d:ibe2d)→wlul (1:iblksmacro, is:ie) are executed, and the process gets out of the sub-routine.

Blocks can be dynamically and one-dimensionally divided and processed and can be updated using the information after decomposition of each node. Transfer can be conducted simultaneously with computation. Therefore, the load of an update portion can be completely equally divided among nodes, and the amount of transfer can be reduced to one obtained by dividing it by the number of nodes.

According to the conventional method, if the width of a block increases, the balance of a load collapses. However, according to the present invention, since the load is equally distributed, paralleling efficiency is improved by approximately 10%. The reduction in the amount of transfer also contributes to the approximately 3% improvement in parallel efficiency. Therefore, even if transfer speed is low compared with the computation performance of an SMP node, less influence on parallel efficiency can be expected.

By computing the LU decomposition of blocks in parallel, not only the degradation of parallel efficiency due to the increase in a portion that cannot be processed in parallel when the width of a block increases, can be compensated, but parallel efficiency can also be improved by approximately 10%. By using a recursive program that targets micro-blocks, diagonal blocks can also be processed in parallel by the parallel operation of SMPs. Therefore, the performance of a SMP can be improved.

What is claimed is:

1. A program for enabling a computer to realize a matrix processing method of a parallel computer in which a plurality of processors and a plurality of nodes including memory are connected through a network, the method comprising:
distributing and allocating one combination of bundles of row blocks of a matrix, cyclically allocated, to each node in order to process the combination of the bundles;
separating a combination of bundles of blocks into a diagonal block, a column block under the diagonal block and other blocks;
redundantly allocating the diagonal block to each node and also allocating one of blocks obtained by one-dimensionally dividing the column block, to each of the plurality of nodes while communicating in parallel;
applying LU decomposition to both the diagonal block and the allocated block in parallel in each node while communicating among nodes; and
updating the other blocks of the matrix, using the LU-decomposed block.

2. The program according to claim 1, wherein the LU decomposition is executed in parallel by each processor of each node in a recursive procedure.

3. The program according to claim 1, wherein
in said update step, while computing a row block, each node transfers data that belongs to a computed block and is needed to update other blocks, to other nodes in parallel to the computation.

4. The program according to claim 1, wherein
said parallel computer is a SMP node distributed-memory type parallel computer in which each node is a SMP (symmetric multi-processor).

5. A matrix processing device of a parallel computer in which a plurality of processors and a plurality of nodes including memory are connected through a network, comprising:
a first allocation unit distributing and allocating one combination of bundles of row blocks of a matrix, cyclically allocated, to each node in order to process the combination of the bundles;
a separation unit separating a combination of bundles of blocks into a diagonal block, a column block under the diagonal block and other blocks;
a second allocation unit redundantly allocating the diagonal block to each node and also allocating one of blocks obtained by one-dimensionally dividing the column block, to each of the plurality of nodes while communicating in parallel;
an LU decomposition unit applying LU decomposition to both the diagonal block and the allocated block in parallel in each node while communicating among nodes; and
an update unit updating the other blocks of the matrix using the LU-decomposed block.

6. A matrix processing method of a parallel computer in which a plurality of processors and a plurality of nodes including memory are connected through a network, comprising:
distributing and allocating one combination of bundles of row blocks of a matrix, cyclically allocated, to each node in order to process the combination of bundles of blocks;
separating a combination of bundles of blocks into a diagonal block, a column block under the diagonal block and other blocks;
redundantly allocating the diagonal block to each node and also allocating one of blocks obtained by one-dimensionally dividing the column block, to each of the plurality of nodes while communicating in parallel;
applying LU decomposition to both the diagonal block and the allocated block in parallel in each node while communicating among nodes; and
updating the other blocks of the matrix, using the LU-decomposed block.

7. A computer-readable storage medium on which is recorded a program for enabling a computer to realize a matrix processing method of a parallel computer in which a plurality of processors and a plurality of nodes including memory are connected through a network, the method comprising:
distributing and allocating one combination of bundles of row blocks of a matrix, cyclically allocated, to each node in order to process the combination of the bundles;
separating a combination of bundles of blocks into a diagonal block, a column block under the diagonal block and other blocks;
redundantly allocating the diagonal block to each node and also allocating one of blocks obtained by one-dimensionally dividing the column block, to each of the plurality of nodes while communicating in parallel;
applying LU decomposition to both the diagonal block and the allocated block in parallel in each node while communicating among nodes; and
updating the other blocks of the matrix using the LU-decomposed block.
